(19) United States
(12) Patent Application Publication
(10) Pub. No.: US 2011/0186464 A1
(43) Pub. Date: Aug. 4, 2011

(54) Process for manufacturing glass containers and product obtained therewith

(75) Inventors: Giovanni Carta, Piombino Dese (IT); Fabiano Nicoletti, Piombino Dese (IT); Gilberto Rossetto, Piombino Dese (IT); Pierino Zanella, Piombino Dese (IT)

(73) Assignee: NUOVA OMPI S.R.L., Piombino Dese (IT)

(21) Appl. No.: 12/671,745

(22) PCT Filed: Oct. 11, 2007
(86) PCT No.: PCT/IT2007/000714

§ 371 Date: Mar. 30, 2010

(30) Foreign Application Priority Data
Aug. 3, 2007 (IT) PD2007A000272

(51) Int. Cl. B65D 90/00; C03C 17/245

(52) U.S. Cl. 206/524.6; 427/255.29; 427/255.31; 427/255.34; 427/255.36; 427/255.37

(57) ABSTRACT

A process for manufacturing glass containers completely or partly treated with the chemical vapor deposition (CVD) technique, by which a layer of oxides of Si and/or B and/or Ti and/or Zr and/or Ta and/or Al and/or mixtures of one or more of said elements is deposited with HTAP-MOCVD technique, includes the step of carrying our the deposition during the annealing of the container, by supplying into the annealing furnace a suitable gas mixture of precursor, reactant and transport gas.

### FIELD OF THE INVENTION

The present invention concerns processes for manufacturing glass containers for pharmaceutical, cosmetic, diagnostic uses, and in particular concerns a new process for manufacturing glass containers with the MOCVD (Metal Organic Chemical Vapor Deposition) technique and the product obtained therewith.

### STATE OF THE ART

For preserving pharmaceutical, cosmetic or diagnostic solutions, different types of containers are used, preferably made of glass, like vials, bottles, cartridges and syringes.

It is known that the solutions contained in glass containers interact with the inner glass surface. The interaction that takes place causes first of all the leaching of alkaline elements from the glass surface due to the solution contained therein.

Said leaching may cause an undesired increase in the PH value of the solution and also the ions released by the glass may partially interact with some active ingredients of the products contained therein, thus making them inactive.

In order to solve these problems, particular techniques are employed, involving the chemical deposition of low yield “protective” layers on the inner surface of said containers.

Among these techniques, those known under the CVD (Chemical Vapor Deposition) or PE-CVD (Plasma Enhanced-CVD) acronym, also in its PI-CVD (Plasma Impulse-CVD) variant, involve the use of a gas mixture that, when it reaches certain pressure or temperature values or is activated by plasma such to cause suitable chemical reactions, allows layers, mainly oxide layers, to be deposited on the surface to be covered.

In the known processes for the production of glass containers, chemical vapor deposition (CVD) takes place in one or more specific stages after the container forming and annealing stages.

For example, it is known that the common glass bottles for use in the pharmaceutical sector are mainly produced by hot processing of a neutral glass tube. The end of the tube is first heated until the glass becomes malleable and formed in such a way as to obtain the neck of the bottle; successively the glass tube is flame-cut at a proper distance from the mouth in order to obtain the bottom of the bottle. The latter is then annealed, in order to eliminate all of the permanent stresses created during the forming process, and finally it is packed for transfer to another plant.

The PE-CVD or PI-CVD techniques, in fact, require the use of specifically dedicated rooms, systems and equipment, which consequently involves additional costs in investments, materials, operation, maintenance and labor.

### SUMMARY OF THE INVENTION

A new process for manufacturing glass containers according to the invention requires the application of the MOCVD (Metal Organic Chemical Vapor Deposition) technique for the deposition of a low yield layer on the whole or at least part of the inner surface of the container. The MOCVD technique is applied within the production line and in particular during the container annealing stage, thus optimizing hourly production and costs for investments, materials, equipment, maintenance and labor.

The main object of the present invention is to carry out in the same production line the container forming stage, the application of said MOCVD technique and the annealing of the container, with slight modifications to the already existing and known production lines commonly used for manufacturing glass containers without low yield inner layers.

In this way, it is possible to use the already existing systems and equipment, inserting only the chemical vapor deposition (CVD) segment associated with the container stage, thus exploiting also the thermal energy developed during the annealing stage.

Another important object of the present invention is to produce a glass container for preserving pharmaceutical, cosmetic or diagnostic solutions where the quantity of ions leached from the glass through the solutions is reduced to the minimum and which substantially behaves as an inert barrier vis-a-vis those solutions.

The glass container obtained with a process according to the invention is characterized in that all or at least part of its inner surface is covered by a layer of oxides of Si, B, Ti, Zr, Ta, Al and/or mixtures of these elements, applied with the MOCVD (Metal Organic Chemical Vapor Deposition) technique under high pressure and temperature conditions, during the normal manufacturing process of the glass container.

### DETAILED DESCRIPTION OF THE INVENTION

The inner surface of a glass container obtained by means of a process according to the invention is covered by a layer of oxides of Si, B, Ti, Zr, Ta, Al and/or mixtures of these elements.

Said layer is obtained by means of the HTAP-MOCVD [High Temperature and Atmospheric Pressure Metal Organic Chemical Vapor Deposition] technique.

This technique allows a hard layer to be chemically created on the inner surface of the glass container through the thermal decomposition, in vapor phase, of a suitable volatile metal-organic precursor. The energy required for the dissociation of the gas precursor is obtained through proper heating.

A glass container with layers produced according to this technique features exceptional resistance to leaching and thus behaves in a highly inert manner vis-a-vis the solutions preserved therein.

Layers of oxides, mainly SiO₂ oxides, are particularly suitable for this purpose. The precursors that can be successfully used in this case are compounds with a general formula as follows: [R₂N]ₙSiX₄₋ₙ, where R=alkyl groups and X═H, halogen, alkoxy (OR′) and alkyl groups, in particular tri(dimethylamino)silane, [(CH₃)₂N]₃SiH, thermostatically controlled at a temperature (30° C.) suitable for ensuring effective evaporation and thermal stability.

In this case, for example, deposition takes place at atmospheric pressure in a hot-wall CVD reactor, provided with a Pyrex tube (0=50 mm) heated via a tubular electric furnace.

The transport gas is N₂ of electronic grade (flow rate=50 sccm) passing through a bubbler containing the precursor, that is, for example, said tri(dimethylamino)silane.

The reactant gas (O₂ of electronic grade+vapor) is introduced in the main flow in the vicinity of the reaction area, with a flow rate of 150 sccm. The O₂—H₂O mixture is obtained by making the oxygen bubble in a 500 cc baloon containing 250 cc of distilled water maintained at a temperature of approximately 30° C.

The deposition temperature depends on the composition of the glass in question, while the thickness of the layer depends on both deposition temperature and deposition time.

The resulting layer of silicon dioxide deposited on the inner surface of the container adheres perfectly to it and behaves as an inert barrier to chemical etching.

According to the above description, it is possible, for example, to obtain a layer of SiO₂ approx. 150 nm thick using borosilicate glass, with deposition temperature of 570° C. and deposition time of 150 seconds.

The main advantage of the new process with MOCVD technique under high pressure and temperature conditions lies in that, differently from other known processes, it can be easily applied to any line or industrial process for manufacturing glass containers, with no need to modify it.

In fact, a glass container manufacturing process necessarily comprises a furnace, called annealing furnace, where the container is kept at high temperature (annealing temperature) for the time necessary to reduce its stresses.

During this stage the container can be supplied, in different manners and for the necessary time, with a suitable mixture of precursor, reactant and transport gas.

On the contrary, in the known processes for manufacturing glass containers, the PE-CVD, PI-CVD technique is applied in a distinct stage, at the end of and after the production process, and in particular in a different environment, using specifically dedicated systems and equipment.

The new process, instead, as already explained, allows the MOCVD technique to be used in the annealing furnace, exploiting the thermal energy developed during the annealing stage.

The following table reports the results of the chemical analysis of the solution extracted from a container in borosilicate glass through leaching, having the following chemical composition: 75% SiO₂, 11% B₂O₃, 5% Al₂O₃, 7% Na₂O, 2% CaO+BaO, in the form of a 10 ml bottle for injectable solutions, whose inner surface is provided with a 150 nm layer of SiO₂ applied according to said HTAP-MOCVD technique, tested on the base of the provisions of the European Pharmacopoeia 5th edition (2005), currently in force, regarding “Glass containers for pharmaceutical use—Hydrolytic resistance”.

In the same table, said results are shown compared to the results obtained using an identical bottle for injectable solutions not provided with the layer of the invention on its inner surface. Each one of the values indicated is an average value obtained from the analyses carried out on 100 samples of glass containers.

| | Bottle with layer | Bottle without layer |
|---|---|---|
| | (μg/ml) | (μg/ml) |
| Na₂O | <0.01 | 4.80 |
| CaO | <0.05 | 0.23 |

In the glass containers manufactured according to the present invention, the quantity of leached cations always remains below the detection limits.

In particular, the layer of SiO₂, chemically deposited, which forms a barrier between the pharmaceutical or diagnostic solution and the glass matrix, is scarcely leachable and highly inert.

The leachable quantity of Na cation, in fact, is below 0.01 ppm, while the leachable quantity of Si is below 0.30 ppm, when a 10 ml glass container with internal layer obtained according to the present invention is tested according to the European Pharmacopoeia 5th edition (2005) for 1 hour at the temperature of 121° C.

The enclosed drawings schematically represent the new process and the equipment used, as examples without limitation.

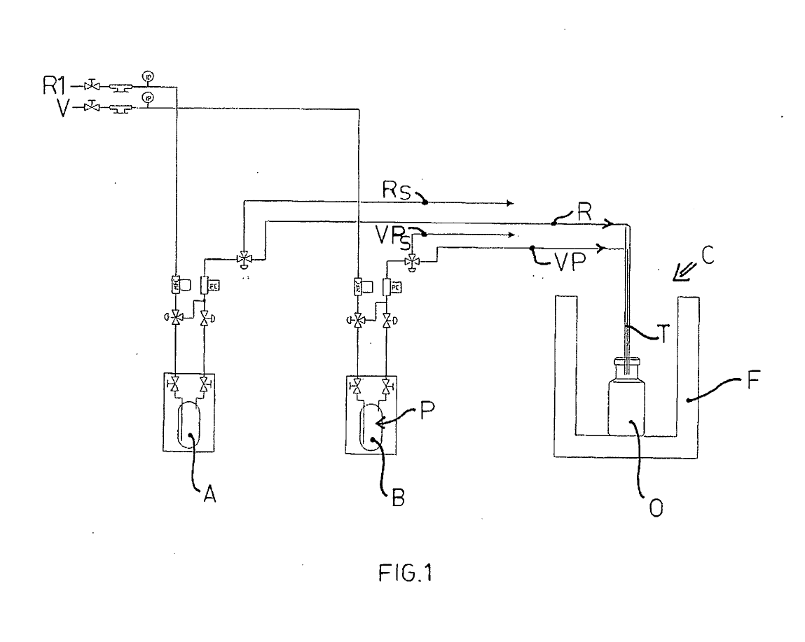

FIG. 1 shows the MOCVD deposition process inside a bottle (O).

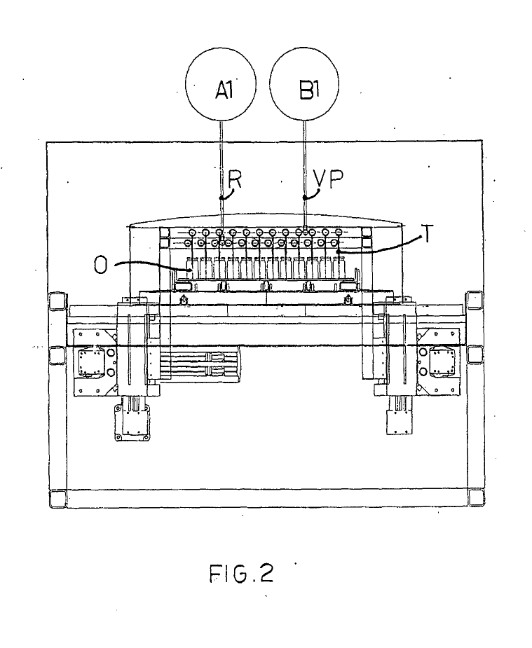

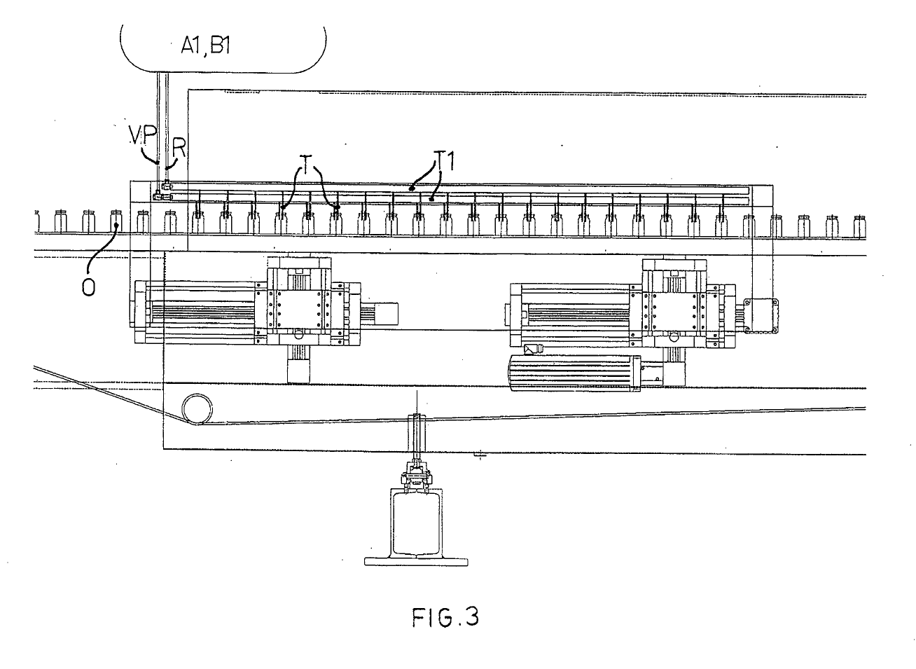

FIGS. 2 and 3 are two schematic views of a possible industrial application of the new process.

As shown in FIG. 1, the deposition (C) takes place at atmospheric pressure in a hot-wall CVD reactor (F) provided with a Pyrex tube (Ø=50 mm) heated via a tubular electric furnace.

The transport gas (V) is N₂ of electronic grade (flow rate=50 sccm) passing through a bubbler (B) containing the precursor (P), which is, for example, said tri(dimethylamino)silane.

The reactant gas (R1), that is O₂ of electronic grade+vapor, is introduced in the main flow in the vicinity of the reaction area, with a flow rate of 150 sccm. The O₂—H₂O mixture (R) is obtained by making the oxygen (R1) bubble in a 500 cc balloon (A) containing 250 cc of distilled water maintained at approximately 30° C.

The reaction mixture (R) and the mixture made up of transport gas and precursor (VP) flowing out of said balloon (A, B) are injected (T), except for a waste portion (Rs, VPs), into the glass container (O), on whose internal surface the deposition (C) takes place.

FIGS. 2 and 3 show the equipment where the reaction mixture (R) and the transport gas-precursor mixture (VP) are taken from the respective tanks (A1, B1) and injected inside the glass containers (O) by means of a series of injectors (T1, T).

Therefore, with reference to the above description and the attached drawings, the following claims are expressed.

1. A process of manufacturing a glass container completely or partly treated with chemical vapor deposition (CVD), comprising the steps of:
depositing an inner layer of one or more of an oxide of Si, B, Ti, Zr, Ta, or Al, or a mixture thereof with a HTAP-MOCVD technique,
wherein said deposition is carried out during annealing of the container by supplying an annealing furnace with a suitable gas mixture of precursor, reactant and transport gas, and
wherein said layer provides an inert barrier that prevents an extraction of elements contained in the glass through a solution present in the container.

2. The process according to claim 1, wherein the precursor has a general formula: [R₂N]ₙSiX₄₋ₙ,
where R=an alkyl group and X=one or more of H and an alkyl group.

3. The process according to claim 1, wherein N₂ gas is used as transport gas, and is bubbled together with said precursor.

4. The process according to claim 1, wherein O₂+H₂O is used as reactant gas, and wherein said gaseous oxygen is bubbled in at least one container containing H₂O distilled at controlled temperature.

5. A glass container, comprising:
a surface having a layer is completely or partly provided with HTAP-MOCVD as claimed in claim 1.

6. The glass container according to claim 5, wherein the layer deposited on an entirety or part of the surface contains SiO₂, such that a leachable quantity of Na cations is less than 0.01 ppm, when a 10 ml glass container is tested according to the European Pharmacopoeia 5th edition (2005) for 1 hour at a temperature of 121° C.

7. The process of claim 2, wherein tri(dimethylamino)silane, [(CH₃)₂N]₃SiH] is the precursor for the deposition of silicon dioxide (SiO₂).
